(19) United States
(12) Patent Application Publication
(10) Pub. No.: US 2002/0160751 A1
(43) Pub. Date: Oct. 31, 2002

(54) Mobile devices with integrated voice recording mechanism

(76) Inventors: Yingju Sun, Cupertino, CA (US); Joe Zheng, Cupertino, CA (US)

Correspondence Address: Joe Zheng, 7394 Wildflower Way, Cupertino, CA, 95014, US

(21) Appl. No.: 09/844,922

(22) Filed: Apr. 26, 2001

(51) Int. Cl. H04M 11/10

(52) U.S. Cl. 455/412; 455/556

(57) ABSTRACT

A mobile apparatus is disclosed to provide voice recording capabilities. According to one embodiment, the mobile apparatus includes a mobile device with telephonic capabilities so that a user of the mobile apparatus can make/receive a call while in motion, a recording mechanism integrated within the mobile device and wherein the recording mechanism records an audio input from a user so that the audio input can be replayed later. With the integrated recording mechanism, the mobile apparatus can function as a phone and/or a voice recorder.

### BACKGROUND OF THE INVENTION

1. Field of the Invention

The present invention relates to voice recording systems and more particularly to a mobile device with a built-in voice recording mechanism, wherein the mobile device may be a mobile telephone that sometimes is referred to as a cell phone.

2. Description of the Related Art

The most common reason for wanting to record audio such as one's own voice or the voice of someone being interacted with is accuracy. Where business or financial transactions are being conducted, it may be very helpful to refer back to an audio transcript.

In the last five years, wireless communication devices such as cellular phones have become increasing popular and it has been predicted that there will be 1 billion cellular phones worldwide by the year 2005. The popularity of the cellular phones has penetrated deeply into our lives. One can see people talking on cellular phones nearly everywhere.

One of the reasons that the cellular phones are so popular is the provided convenience. A caller can reach a callee from anywhere, likewise, a callee can receive a call from anywhere. Hence, users depend heavily on the mobility of cellular phones. It is often seen that a user talks on a cellular phone while driving a car. In fact, talking on a phone while driving is dangerous enough. Taking notes while driving could be even more dangerous, which often happens when a user is given an appointment schedule or a phone number in a conversation to remember.

What is needed is a method or an apparatus for recording, perhaps, processing and managing audio content, where that content is captured using a mobile device having an integrated audio recorder therein.

### SUMMARY OF THE INVENTION

An object of the present invention is to provide an apparatus and method for recording audio inputs while a user of a mobile device is on the go. Typically, a user of a cellular phone, when talking on the phone, is away from his/her desk or far away from reaching a writing medium, it is commonly experienced that the user has to remember important things from a conversation carried on the phone, such as a phone number and a schedule. Such important things could be overlooked later if the user could not write them down. The present invention can be advantageously used to facilitate the remembrance of these important things. Further, the present invention can be used to remember items of interests (e.g. an advertisement, a phone number and information from a billboard).

According to one aspect of the present invention, a mobile apparatus includes a mobile device with telephonic capabilities so that a user of the mobile apparatus can make/receive a call while in motion, a recording mechanism integrated within the mobile device and wherein the recording mechanism records an audio input from a user so that the audio input can be replayed later. The mobile device with telephonic capabilities means that the mobile device can be used for voice communications over a wireless network. The mobile device may be a cellular phone. With the integrated recording mechanism, the mobile device is expanded to be a mobile apparatus that can function as a phone and/or a voice recorder.

Existing answering machines facilitate voice recording but could not provide the regular two-way voice communication. Existing telephones with an integrated answering recorder is to provide a single apparatus for answering incoming calls when they are not picked up. Significantly different from those existing machines, the voice recorder in the present invention is not designed to answer incoming calls since in most cases a wireless carrier of wireless voice communication facilities automatic answering features through its base stations or centers. Evidently, it is not obvious to integrate a voice recorder in a wireless phone. As one of the features in the present invention, the voice recorder is used conveniently as an electronic medium for a user on the go to remember things that otherwise would be wrote in a notebook.

According to another aspect of the present invention, the voice recorder operates only when the phone is not engaged in voice communication. As such, the purpose of the voice recorder is not designed to record a conversation carried by the phone. However, it is understood that the voice recorder may be configured or controlled to record a conversation if permitted or only record one side of the conversation by the user of the device.

Many wireless phones have an internal memory space. According to one embodiment, the implementation of the present invention is to utilize some of the components in the phones to facilitate the recording capabilities. For example, a phone includes a microphone for a user thereof to talk to a person on the other side of a conversation and a speaker for the user to listen to the conversation. Accordingly, a voice input can be received from a microphone of the phone. The voice input may be digitized and the digitized voice input can now be stored in memory of the phone. The stored contents may be played back and listened to from the speaker. One of the advantages and benefits of the present invention is to allow a user of a mobile device to record things that the user desires to remind himself/herself of in another time.

The foregoing and other objects, features and advantages of the invention will become more apparent from the following detailed description of a preferred embodiment, which proceeds with reference to the accompanying drawings.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a block diagram of a communications system which may be used to implement the method and system embodying the present invention;

FIG. 2 is a block diagram of cellular telephone having an integrated audio recording device in accordance an embodiment of the present invention;

FIG. 3 illustrates a functional block diagram of the components associated with a representative cellular telephone having an integrated audio recording device in accordance with an embodiment of the present invention;

FIG. 4 illustrates a functional block diagram of the functional software modules associated with a representative cellular telephone having an integrated audio recording device in accordance with an embodiment of the present invention;

FIGS. 5A through 5J illustrate representative graphical user interfaces associated with a cellular telephone having an integrated audio recording device in accordance with an embodiment of the present invention;

FIG. 6 illustrates a representative graphical user interface for an associated personal computer archival management program in accordance with an embodiment of the present invention; and

FIG. 7 is a flow diagram of the process associated with processing, storing, annotating and managing recorded audio content in accordance with an embodiment of the present invention.

### DETAILED DESCRIPTION OF THE INVENTION

The invention pertains to a method and a system for recording, processing, storing and annotating audio input using a mobile phone having an integrated audio recorder whose mode of operation is regulated by pre-defined rules which are associated with the phone's operational parameters (i.e., power management setting, functional settings etc.) and regulations (i.e., federal laws, state laws, and operator originated rules).

Mobile phones, also referred to as a wireless two-way communications device, include but are not limited to wireless cell phones, cellular phones, smart phones, palm-sized computing devices having telephone-like (telephonic) features, and similar networked audio communication devices. Such devices typically have a user interface comprised of a display and a keyboard/keypad, a microphone and a speaker.

The detailed description of the present invention is presented largely in terms of procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

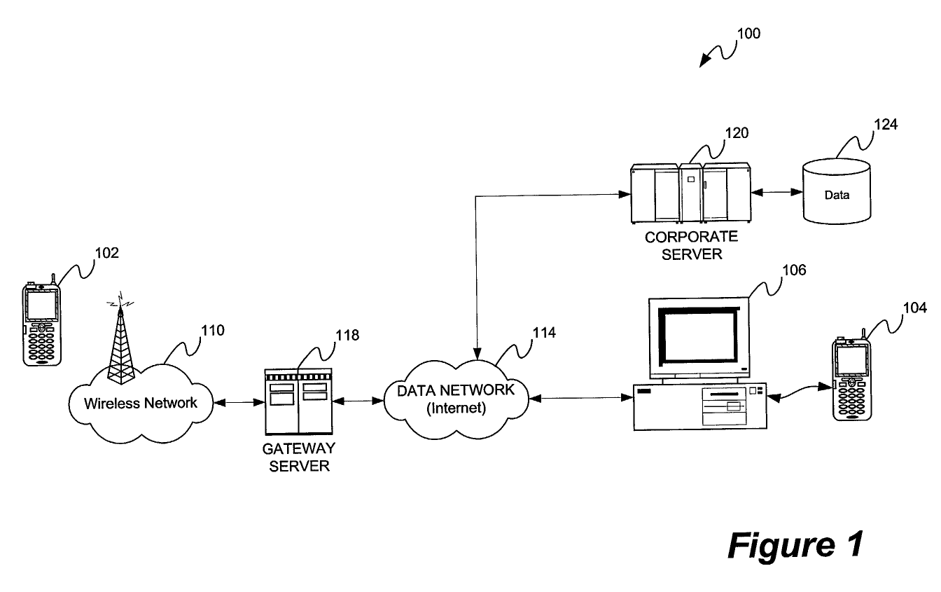

Referring now to the drawings, in which like numerals refer to like parts throughout the several views. FIG. 1 shows an exemplary system configuration in which the present invention may be implemented in accordance with an embodiment. Cellular telephones having Audio Recording Capabilities (ARC) 102 and 104 (also referred to as ARC phones herein) have access to a wireless communication network 110. ARC phones 102 and 104 also have access to a land based data communications network 114 either through gateway server 118 or through networked personal computer 106. Access to remote server devices such as corporate server device 120 is through land based data communications network 114.

In accordance with an embodiment of the present invention, ARC phones 102 and 104 can be used to record audio input from a user thereof or to process an electrical representation of the audio input. The operations associated with recording, processing, storing and annotating the audio input using the ARC phones may be regulated by pre-defined rules associated with operational parameters of the subject device or predefined regulations. For example, the recording of the audio input is set to occur only when the phone is off line (to avoid any possible legal implications), subject to a time duration determined by the memory capacity in the phone, and the recorded audio input may be replayed, processed or transferred.

Optionally, ARC phone 102 (or 104) can selectively function as an electronic Dictaphone or it can be used to record telephone calls so long as the recording operations performed are in accordance with predefined rules which may be derived from authoritative regulations (i.e., Federal defined, State defined, Municipality defined, carrier-defined, organization defined). For example, if a state or municipality allows recording only if all the participating parties are in agreement, the call recording feature will be inactivated unless some action is taken (i.e., a digital agreement) that affirms that all parties concerned have agreed to have the call recorded. Additionally, the device may be configured so that only the parties agreeing to the recording will have their voices recorded while the other parties have there audio input muted.

Once audio inputs have been recorded as audio files in digital format, they can be annotated using information resident on the subject devices (i.e., ARC phones 102 or 104) or on remotely accessible devices, such as time stamping the audio files. According to one embodiment, the audio files may be stored locally or transferred to a remote device for archival such as corporate server device 120 or personal computer 106 using the wireless communications network or through a Hot-Sync type connection (i.e., through personal computer 106).

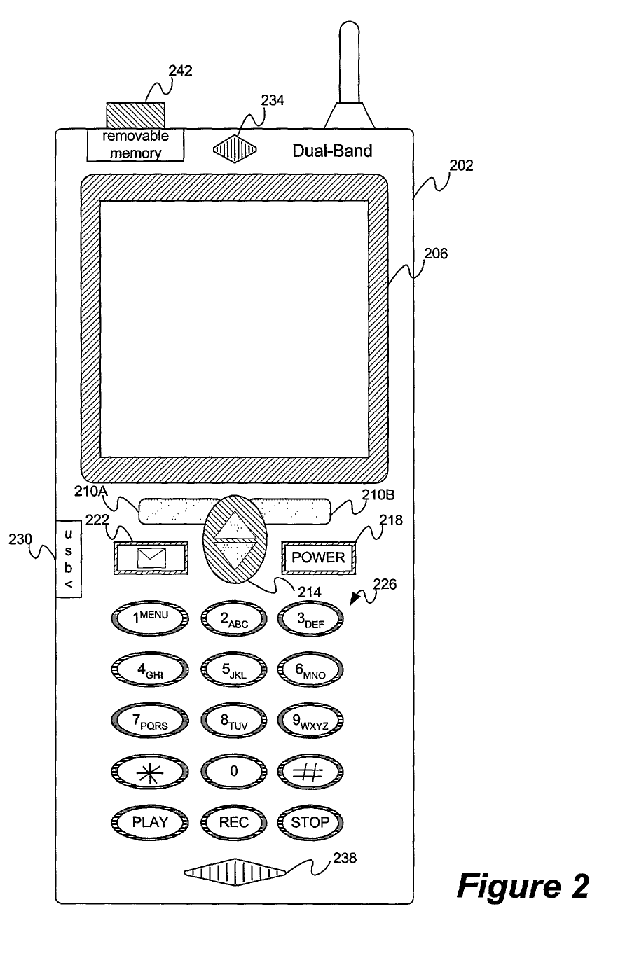

Referring to FIG. 2, a representative ARC phone 202, which may be ARC phone 102 or 104 of FIG. 1, is illustrated. ARC phone 202 includes LCD display 206, softkeys 210A and 210B, navigation keyset 214, dedicated function keys <POWER> 218 and <e-Mail> 222, keypad 226 with additional keys for recorder operation, a universal serial bus port 230, speaker 234, microphone 238 and removable memory 242 (i.e., a Sony 64 MB MemoryStick™). The user interface, as described above, and resident software modules which will be described below, control both phone functions and recorder functions in accordance with a preferred embodiment of the present invention.

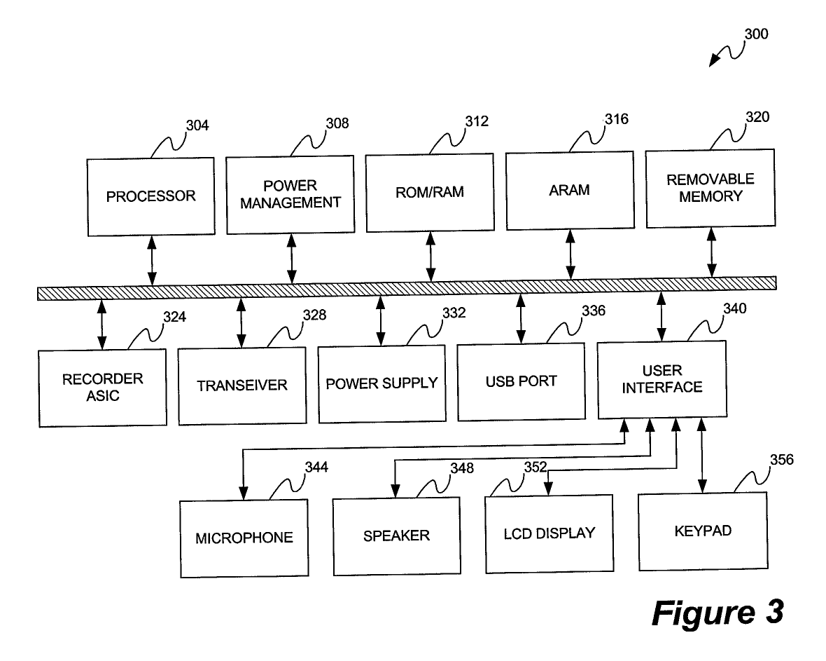

FIG. 3 illustrates a functional block diagram of hardware components associated with a representative cellular telephone having Audio Recording Capabilities (ARC) 300 in accordance with one embodiment of the present invention. ARC phone 300 combrises a processor 304, a power management module 308 which may take the form of an ASIC or a software module processed by processor 304, ROM/RAM 312, Audio grade dynamic RAM (ARAM) 316 (e.g., AT45D041 Serial DataFlash 4-megabit flash memory from Atmel Corporation), Removable Memory 320 (e.g. Sony 64 MB MemoryStick™), recorder ASIC 324 (e.g., DSP160x family of digital signal processors from Lucent Microlectronics), transceiver 328, power supply 332, USB port 336, and user interface 340 which controls microphone 344, speaker 348, LCD display 352 and keypad 356. Other common components, such as Analog-to-Digital (A/D) converter, are not shown in the figure, to avoid obscuring aspects of the present invention. However, it is known to those skilled in that art that not every component in FIG. 3 has to be employed in order to practice the present invention.

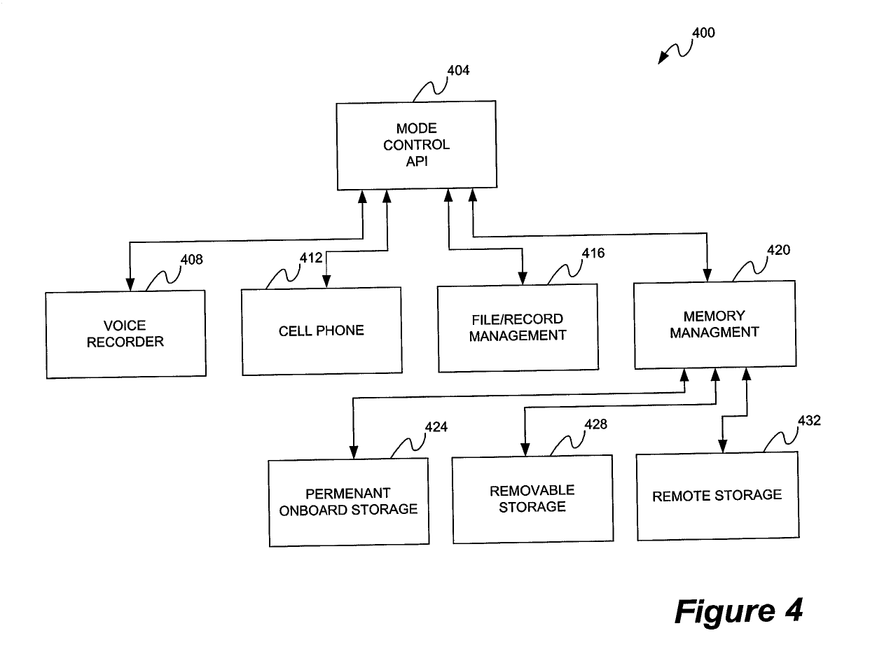

FIG. 4 illustrates a functional block diagram of a software control module 400 associated with a representative ARC phone which may be used to implement functions contemplated in the present invention. According to one embodiment, module 400 includes mode control 404, a voice recorder control module 408, a cell phone control module 412, a file/record management control module 416, and a memory management control module 420. In operation, model control 404 that may be controlled through one or more of the keys in the keypad determines an operation mode, for example, talking mode, recording mode, talking/recording mode and file management mode. In that talking mode that may be configured to be default when the phone is on line, the recording capability is suspended. In the recording mode, audio inputs from a user can be recorded off line, namely, the recording only occurs when the phone is off line. In talking/recording mode, the integrated voice recorder is used to record the conversation on the line. The memory management control module controls permanent onboard storage (i.e., ARAM 316 of FIG. 3), removable storage 428 (i.e., removable memory module 320 of FIG. 3) and remote storage 422.

In accordance with an embodiment of the present invention, when an ARC phone is recording a telephone conversation, its mode of operation is effected by parameters and user-presets. In one embodiment, some of the parameters are related to pre-defined rules that have been stored locally on the subject device or are accessible through a remote server device. These pre-defined rules are derived from Federal, State and Municipal laws or from regulations originating from the wireless service provider or some other entity having administrative control over the communications channel. For example, in the state of Maryland, permission is required from all parties involved to record a phone call. In another embodiment, since, cellular phones are geographically aware of their physical location, the ARC phone could have its recording mode of operation suspended while on a phone call in the state of Maryland unless there is some affirmative indication that permission for recording has been given, or the ARC phone may only record the portion of the conversation passing the ARC phone user's microphone.

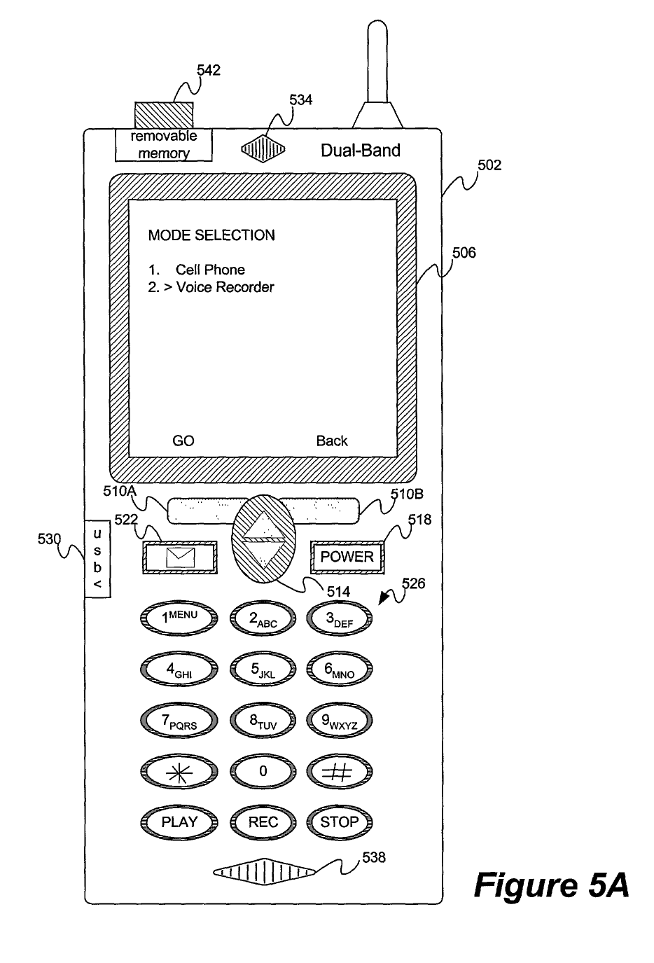

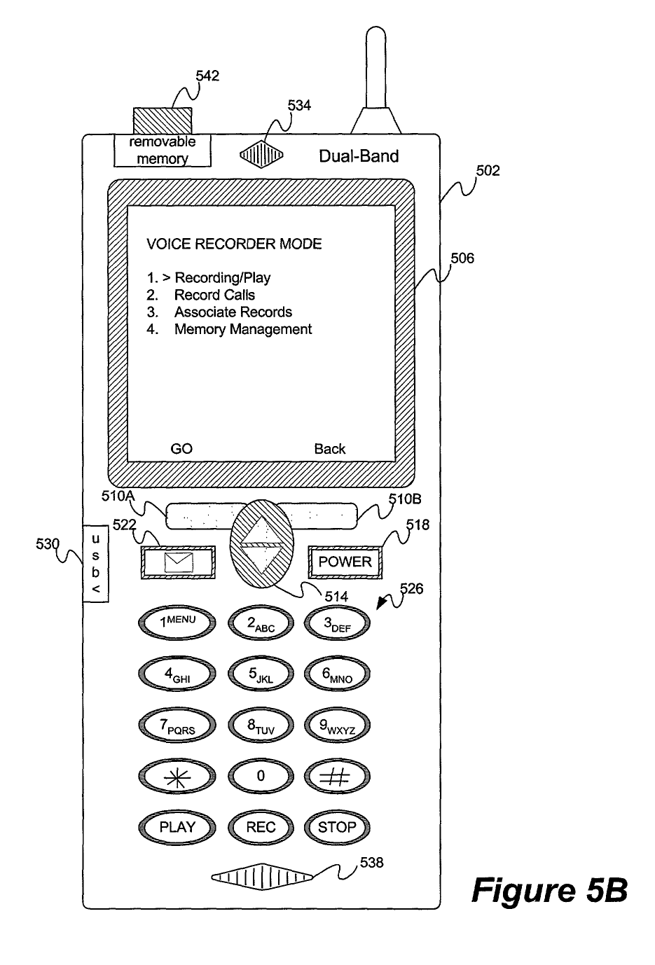

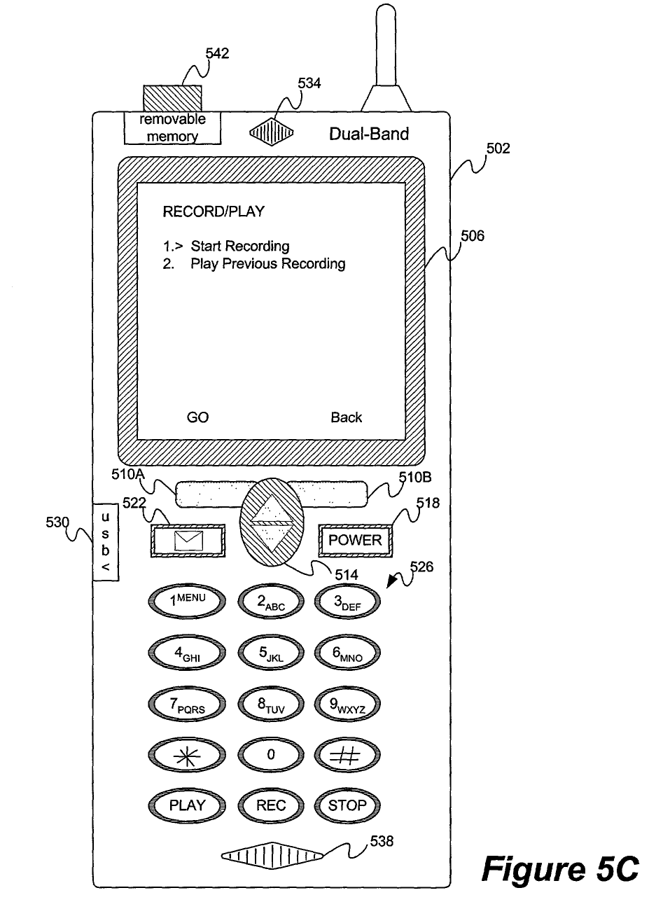

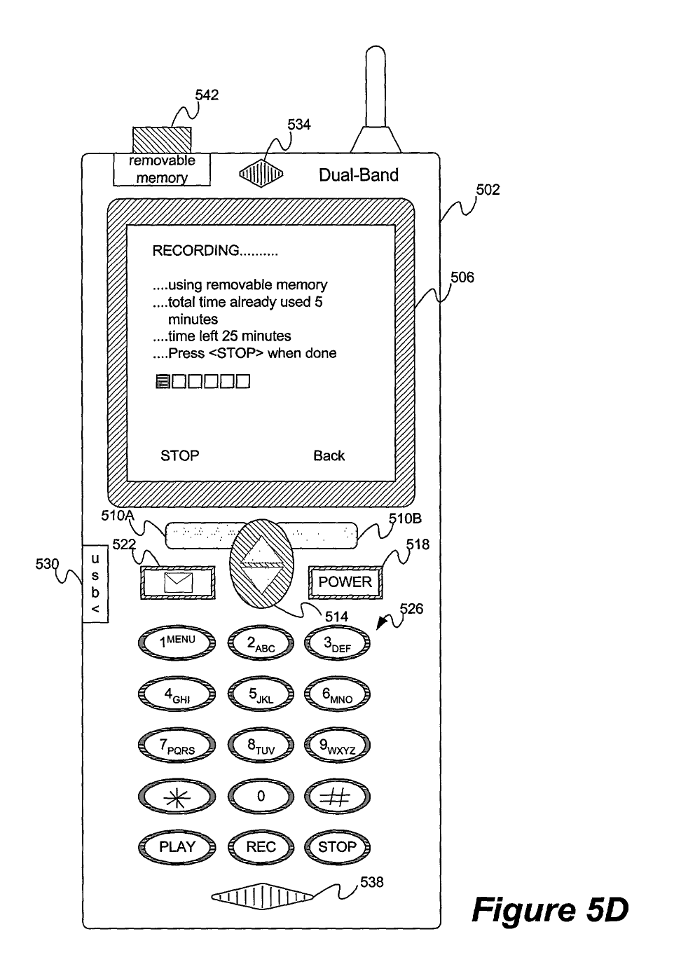

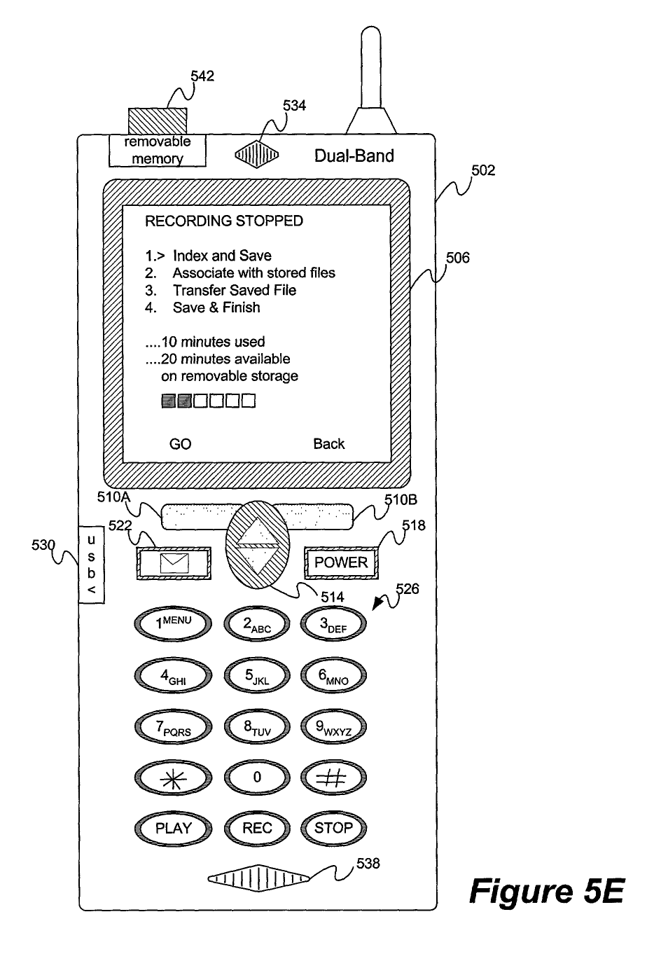

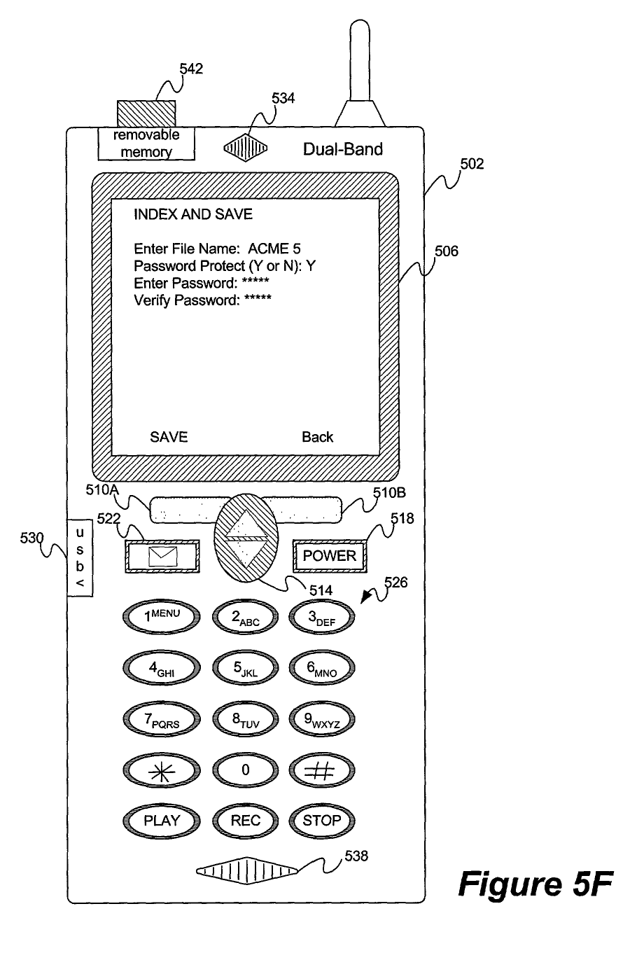

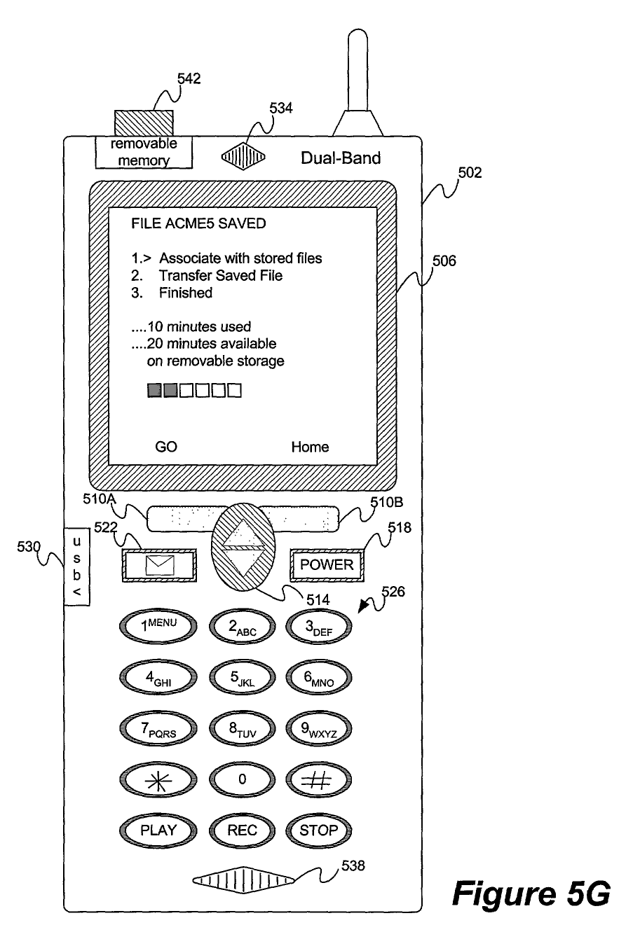

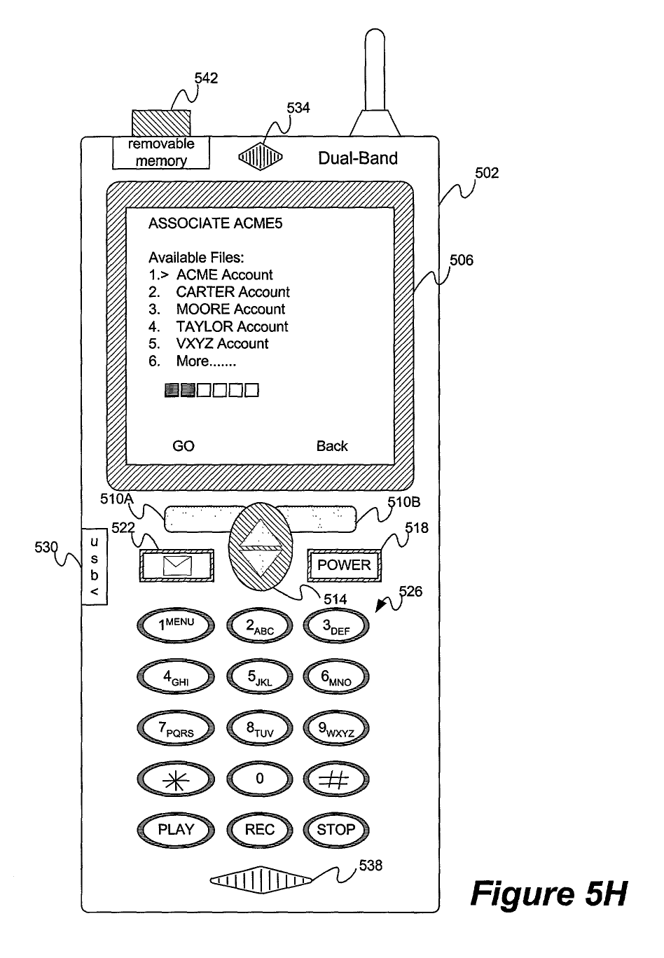

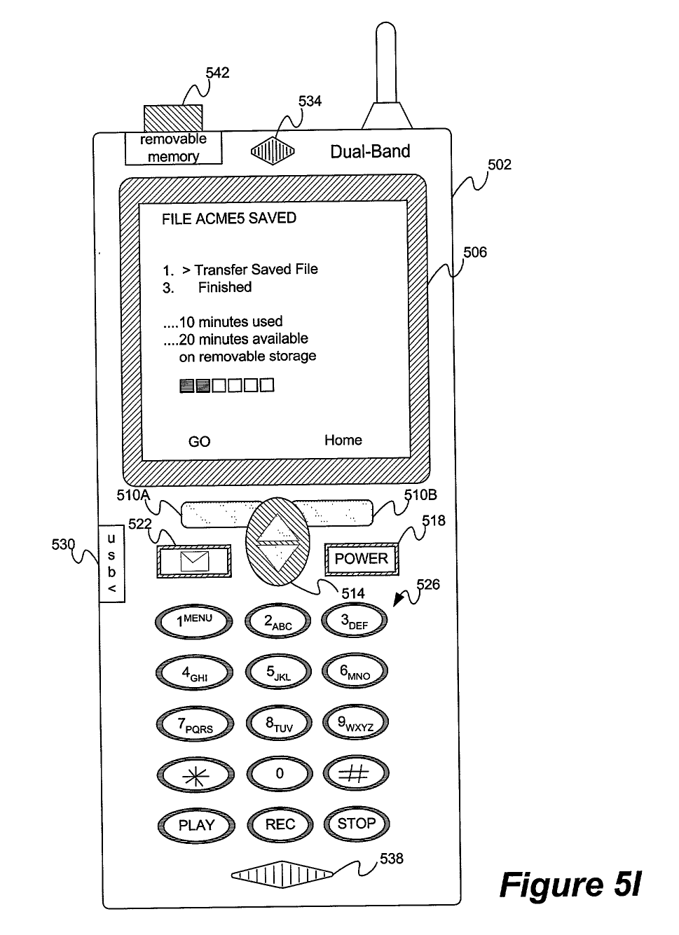

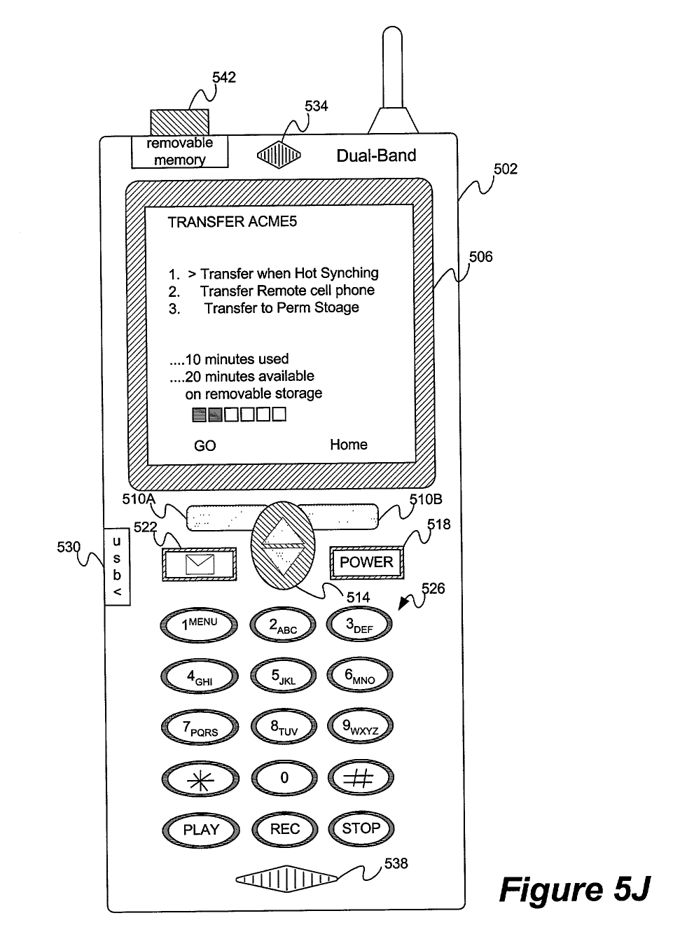

FIGS. 5A through 5J illustrate representative graphical user interfaces (GUI) associated with a cellular telephone having an integrated audio recording mechanism in accordance with an embodiment of the present invention. Referring to FIG. 5A, a mode selection GUI is displayed on display 506 of ARC phone 502 which may correspond to ARC phone 102 or 104 of FIG. 1. On this GUI screen, q user may select a desired operational mode. In FIG. 5A, the <Voice Recorder> option has been selected using navigational keyset 514. Activating softkey 510A will place ARC phone 502 in Voice recorder mode of operation and the GUI will change as illustrated in FIG. 5B.

Referring to FIG. 5B, the Voice Recorder control GUI is displayed. On this GUI, the user has access the control features associated with playing and recording audio input, set up features for recording telephone calls, tools for associating recorded content with previously stored records and for utilities for memory management. In the example provided the <Recording/Play> option has been selected. Activation of softkey 510A will place ARC phone 502 in the Record/Play mode of operation as is illustrated in FIG. 5C.

Referring to FIG. 5C, the Record/Play GUI is displayed. On this GUI the user has access to the control features associated with recording audio input or playing previously recorded audio files. In the example provided the <Start Recording> option has been selected. Activation of softkey 510A will place ARC phone 502 in the recording mode of operation as is illustrated in FIG. 5D.

Referring to FIG. 5D, the Recording GUI is displayed. On this GUI the user is provided with indicators relating to the memory type being used to record the audio input, memory already used (measured in time based on current mode of operation), memory remaining, instructions on how to stop recording and a graphic showing the usage of the memory module. It is important to note at this point that multiple memory modules (removable, non-removable or a mixture) can be used in a single recording session. Pressing the <STOP> key or the softkey 510A will cause the recording process to stop and the GUI illustrated in FIG. 5E to be displayed.

Referring to FIG. 5E the file annotation GUI is displayed. Using this GUI a user can access GUI's for annotating the recorded audio input, associate it with previously stored files resident locally or on some remote storage device, transfer the recorded and annotated file to a remote storage type or from one type of local memory to another (i.e., permanent to removable memory), and utilities for saving the subject content locally without providing annotation. In the example provided the <Index and Save> option has been selected. Activation of softkey 510A will place ARC phone 502 in the Index and Save mode of operation as is illustrated in FIG. 5F.

Referring to FIG. 5F, the Index and Save GUI is displayed. Using this GUI a user can provide an identifier for the recorded audio content, and password protect it if needed. Activation of softkey 510A (<SAVE>) will save the annotated file and change the display to a modified annotation page as is illustrated as an example in FIG. 5G.

Referring to FIG. 5G, a modified annotation page is displayed. Using this GUI the user can associate the annotated audio file with previously stored records (i.e., email, documents other audio files etc.), transfer the annotated files or conclude the process. In the example provided the <Associated with stored files> option has been selected. Activation of softkey 510A (<SAVE>) will change the display to the file association GUI illustrated in FIG. 5H.

Referring to FIG. 5H, the file association GUI is displayed. Using this GUI a user can associate the recorded audio file with previously stored files or file groups. In the example provided the <ACME Account> file group has been selected. Activation of softkey 510A will associated the recorded audio file with the ACME account group and change the display to a modified annotation page GUI as is illustrated in FIG. 5I.

Referring to FIG. 5I, a modified annotation page GUI is displayed. Using this GUI a user can access utilities associated with transferring saved audio files to local or remote resources. In the example provided the <Transfer Saved File> is selected. Activation of softkey 510A will change the display to the file transfer page GUI as is illustrated in FIG. 5J.

Referring to FIG. 5J, the file transfer page GUI is displayed. Using this GUI a user can transfer saved audio files locally between memory types or to remote archives as required. Remote transfers may be carried out using a wireless communications channel or a Hot-Sync type of operation.

It should be noted that FIGS. 5A-5J are provided to demonstrate one type of cellular phones that can be integrated with a voice recorder internally. Those skilled in the art will understand that other types of cellular phones or mobile device with telephonic capabilities may deploy various graphic or non-graphic user interfaces, hence leading to possible different interactions, to facilitate the use of the integrated voice recorder therein.

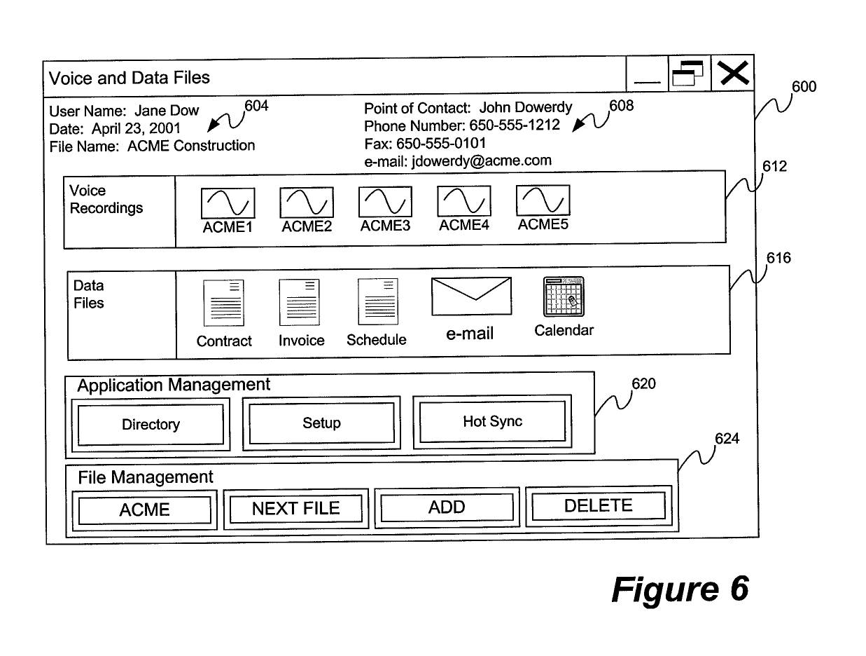

FIG. 6 illustrates a representative graphical user interface (GUI) for an associated personal computer archival management program in accordance with an embodiment of the present invention. This GUI illustrates the relationship between the archived audio files and their association to other file types. Specifically, the archived audio files can be associated with text files and other user applications (i.e., voice recognition programs, calendars, email etc.).

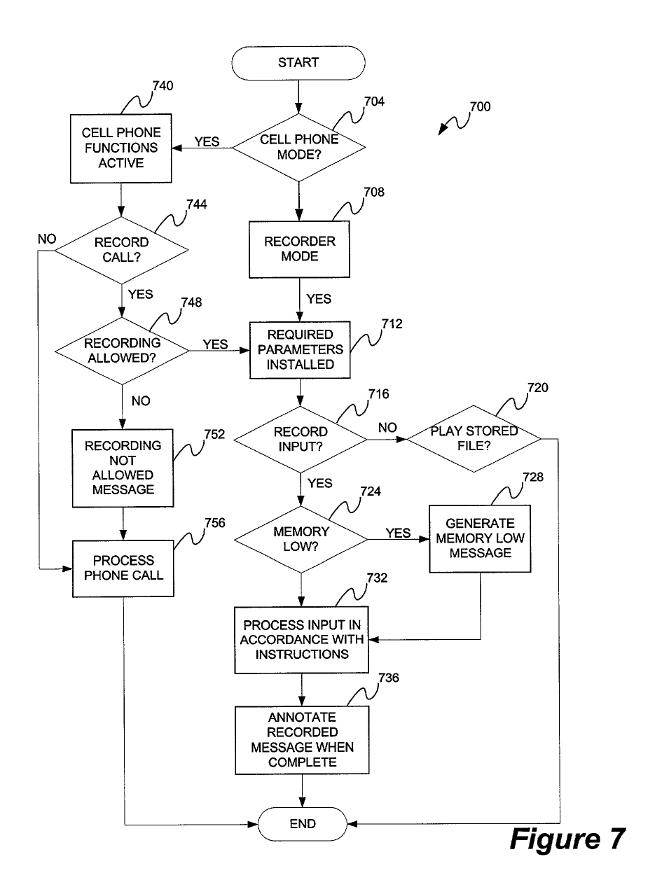

FIG. 7 is a flow diagram of a process associated with recording an audio content, processing, storing, annotating or managing the recorded audio content in accordance with an embodiment of the present invention. At 704 a determination is made as to whether the device is to be placed in the talking (calling) mode. The alternative mode of operation is as an audio recording device at 708.

When it is determined that the operation mode is for recording, recorder parameters (for recording and playing) are activated at 708. At 716 a determination is made as to whether an audio input should be recorded. If recording is selected then the memory status is monitored at the beginning of, and during the recording process. If memory resources are determined to be low, a warning (audio or text) may be issued. Additionally, if an alternate memory resource is available, the destination storage device may be changed (i.e., permanent memory to removable memory) automatically or selectively. At 732 the audio input is processed in accordance with the set parameters and the process may move to 736 in which the user may annotate the recorded contents.

If at 704 the cell phone mode of operation is selected, the calling functionality is applied at 740. A determination is made at 744 as to whether an incoming or established phone call is to be recorded. If the call is not to be recorded then it processed normally without recording at 756 and process is concluded. If the call is to be recorded then a determination is made at 748 as to whether preset guidelines, as previously described, permit the recording of the subject call or the manner to be allowed for recording the call. It is important to note at this point that these guidelines may be changed dynamically as required depending on the location of the participating entities and any associated network or regulatory parameters. If recording is allowed with constraints then those constraints are identified at 748 and implemented at 712. If recording is not allowed then a message is generated at 752 and the call is processed at 756 without recording.

The invention may be implemented as an apparatus, a method or a computer product or take the form of a computer readable code on a computer readable medium, each yielding one or more of the following advantages and/or benefits. One of them is that now a user of mobile phone can immediately record what is important in a phone conversation right after or in the middle of the phone conversation. Another one is that the present invention allows the user to manage the recorded contents, for example, replay to recall what is recorded, manage the recorded contents and transfer the contents to another computing device through a data network or a coupling mechanism. Other advantages or benefits are apparent to those skilled in the art from the description herein.

The present invention has been described in sufficient detail with a certain degree of particularity. It is understood to those skilled in the art that the present disclosure of embodiments has been made by way of examples only and that numerous changes in the arrangement and combination of parts may be resorted without departing from the spirit and scope of the invention as claimed. While the embodiments discussed herein may appear to include some limitations as to the presentation of the information units, in terms of the format and arrangement, the invention has applicability well beyond such embodiment, which can be appreciated by those skilled in the art. Accordingly, the scope of the present invention is defined by the appended claims rather than the forgoing description of embodiments.

I claim:

1. A mobile apparatus comprising:
a mobile device with telephonic capabilities so that a user of the mobile apparatus can make/receive a call while in motion, the mobile device including a user interface;
a recording mechanism integrated within the mobile device and controllable through the user interface; and
wherein the recording mechanism records an audio input from a user so that the audio input can be replayed later.

2. The mobile apparatus of claim 1, wherein the mobile device includes a processor and a digital memory space; and wherein the recording mechanism operates under the processor and digitizes the audio input into an audio file that is stored in the digital memory space.

3. The mobile apparatus of claim 2, wherein the digital memory space is either non-removable memory or removable memory.

4. The mobile apparatus of claim 2, wherein the digital memory space is Audio grade dynamic RAM.

5. The mobile apparatus of claim 1, wherein the recording mechanism only records the audio input from the user when the mobile device is off line.

6. The mobile apparatus of claim 1, wherein the mobile device includes a digital memory space, a microphone and a speaker; and wherein the recording mechanism is used as an audio recorder to record the audio input received from the microphone, to store the recorded audio input in the digital memory space when the mobile device is off line.

7. The mobile apparatus of claim 6, wherein the recorded audio input is replayed and listened to through the speaker.

8. The mobile apparatus of claim 1, wherein the user interface includes a set of keys and a display, the display displaying options for the user to place the mobile apparatus in a desired operation mode.

9. The mobile apparatus of claim 8, wherein the desired operation mode includes recording mode, calling mode and recording/calling mode; and wherein:
the mobile apparatus functions as a telephone when the calling mode is selected;
the mobile apparatus functions as an audio recorder when the recording mode is selected; and
the mobile apparatus functions as a conversation recorder when the recording/calling mode is selected.

10. The mobile apparatus of claim 1, wherein the mobile device is capable of data communication with another computing device; and wherein the audio input is processed in the mobile device and the processed audio input can be transferred to the another computing device.

11. A mobile apparatus comprising:
a wireless telephone including a processor, a digital memory space, a microphone and a speaker; and
an audio recording mechanism integrated within the wireless telephone and operating under the processor, the audio recording mechanism recording an audio input received from the microphone when the wireless telephone is not in telephonic operations.

12. The mobile apparatus of claim 11, wherein the audio input is digitized and the digitized audio input is stored in the digital memory space.

13. The mobile apparatus of claim 12, wherein the digitized audio input stored in the digital memory space can be replayed and listened to.

14. A method for using an mobile apparatus, the method comprising:
providing the mobile apparatus, wherein the mobile device includes:
a wireless telephone having a microphone and a speaker; and
an audio recording mechanism integrated within the wireless telephone;
using the audio recording mechanism to record an audio input while not using the wireless telephone; and
playing back the recorded audio input from the audio recording mechanism through a speaker of the wireless telephone.

15. The method of claim 14 further comprising:
forwarding the recorded audio input to a different device; and
playing back the recorded audio input from the different device.
